(19) United States
(12) Patent Application Publication
(10) Pub. No.: US 2020/0093163 A1
(43) Pub. Date: Mar. 26, 2020

(54) ALCOHOLIC BEVERAGE

(71) Applicant: Jacqueline Marie Carson, Slippery Rock, PA (US)

(72) Inventor: Jacqueline Marie Carson, Slippery Rock, PA (US)

(21) Appl. No.: 16/689,711

(22) Filed: Nov. 20, 2019

Related U.S. Application Data
(63) Continuation-in-part of application No. 16/178,207, filed on Nov. 1, 2018.
Application No. 16/178,207 is a continuation-in-part of application No. 15/017,590, filed on Feb. 6, 2016, now abandoned.

(51) Int. Cl. A23L 9/10; A23L 29/20; A23L 33/26; A23L 33/105; A23L 29/00

(52) U.S. Cl. CPC A23L 9/12; A23L 29/20; A23L 29/035; A23L 33/105; A23L 33/26

(57) ABSTRACT

An alcoholic beverage that includes a solution for aiding in the consumption of the alcoholic beverage that includes sucralose, sodium citrate, and a gelling agent, along with cannabidiol (CBD). The solution is adapted to reduce the feeling of alcohol burn within the mouth and throat of a person consuming the alcoholic beverage, and includes the health benefits of cannabidiol (CBD).

### CROSS-REFERENCE TO RELATED APPLICATION

The instant application is related to and claims priority from prior non-provisional application Ser. No. 15/017,590, filed Feb. 6, 2016, and non-provisional application Ser. No. 16/178,207, filed Nov. 1, 2018 which are incorporated herein by reference.

### FIELD OF THE INVENTION

The presently disclosed embodiments are related, in general, to an improved alcoholic beverage. More particularly, the presently disclosed embodiments are related to an improved alcoholic beverage containing sucralose, sodium citrate, a gelling agent, and cannabidiol.

### BACKGROUND OF THE INVENTION

A JELL-O shot is a portion of JELL-O mixed with a type of alcohol. These shots generally contain a very high level of alcohol. Swallowing chunks of this JELL-O is an entertaining way of ingesting a generous amount of alcohol. These products are generally used at parties or other events where people are celebrating. However, the alcohol produces a burning sensation within the mouth and throat people eating or drinking these items.

There is a need to provide a mixture of ingredients to be used within these JELL-O shots to avoid that burning sensation. There is a further need to include an ingredient to help relax a person and/or relieve pain and stress after ingesting these JELL-O shots.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY OF THE INVENTION

The instant invention and preferred embodiment is set forth as an improved alcoholic beverage combining an alcoholic drink with sucralose, sodium citrate, a gelling agent, and cannabidiol to reduce and/or avoid the burning sensation caused by alcohol consumption and to further help relax a person and/or relieve pain and stress after ingesting these ingredients.

According to embodiments illustrated herein, there is also provided an apparatus for evenly storing and distributing equivalent amounts of a solution pertaining to a food or liquid. The apparatus includes a plurality of compartments and a closing sheet. The plurality of compartments spaced at pre-defined intervals adapted to receive the ingredients of the instant invention. In one embodiment, the plurality of compartments has a closed bottom end and an insert top end. A closing sheet is used to cover a plurality of compartments from an insert top end in order to preserve the ingredients. In one embodiment, the closing sheet has a plurality of seal marks spaced at pre-defined intervals. In one embodiment, the plurality of compartments are made from high-density polyethylene.

In one embodiment, the ingredients include a gelatin dessert and/or a pudding shot. In one embodiment, the covering sheet receives a machine seal in order to get glued with the plurality of compartments.

According to embodiments also illustrated herein there is provided a method for evenly storing and distributing equivalent amounts of ingredients. The method includes the step of receiving the ingredients through a plurality of compartments spaced at pre-defined intervals. In one embodiment, the plurality of compartments has a closed bottom end and an insert top end. The method includes the step of covering the plurality of compartments from the insert top end in order to preserve the solution of the ingredients through a closing sheet, wherein the closing sheet has a plurality of seal marks spaced at pre-defined intervals. Then the step of receiving a machine seal over the covering sheet is incorporated in order to get glued with the plurality of compartments.

These and other features and advantages of the present disclosure may be appreciated from a review of the following detailed description of the present disclosure, along with the accompanying figures in which like reference numerals refer to like parts throughout.

### BRIEF DESCRIPTION OF DRAWINGS

The accompanying drawings illustrate the various embodiments of arrangements, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 illustrates an apparatus for evenly storing and distributing equivalent amounts of a solution pertaining to a food or liquid, in accordance with at least one embodiment;

FIG. 2 illustrates a top view of the apparatus for evenly storing and distributing equivalent amounts of a solution pertaining to a food or liquid, in accordance with at least one embodiment; and

FIG. 3 illustrates a flowchart of a method for evenly storing and distributing equivalent amounts of a solution pertaining to a food or liquid, in accordance with at least one embodiment.

FIG. 4 illustrates a flowchart of the ingredients in the improved alcoholic beverage including the solution for aiding in the consumption of the alcoholic beverage according to the preferred embodiment of the present invention.

### DETAILED DESCRIPTION OF THE DRAWINGS

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

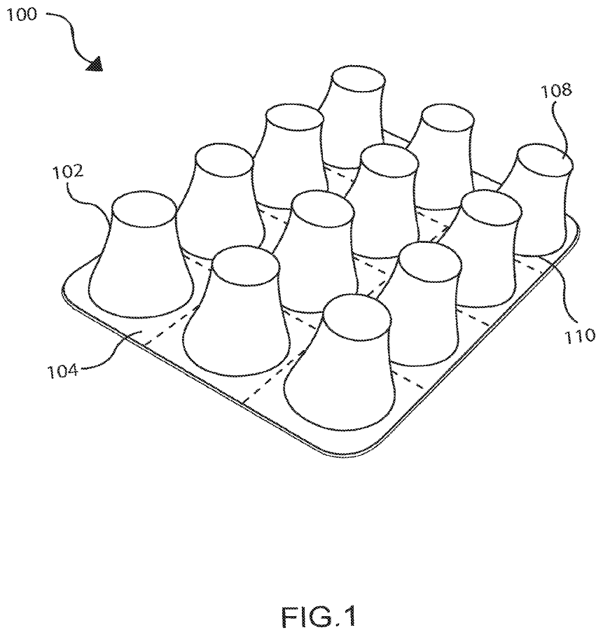

FIG. 1 illustrates an apparatus 100 for evenly storing and distributing equivalent amounts of a solution pertaining to a food or liquid, in accordance with at least one embodiment. The apparatus 100 includes a plurality of compartments 102 and a closing sheet 104. The plurality of compartments 102 spaced at pre-defined intervals adapted to receive the solution of the food or liquid. In one embodiment, the plurality of compartments 102 has a closed bottom end 108 and an insert top end 110.

In one embodiment, the plurality of compartments 102 is made of high density polyethylene (HDPE). Examples of the high density polyethylene includes but not limited to food grade plastic or polyethylene high-density (PEHD). In one embodiment, the solution pertaining to the food is selected from at least one of gelatin dessert; and pudding shot. Gelatin is a protein obtained by boiling skin, tendons, ligaments, and/or bones with water. Pudding is a type of food that may be either a dessert or a savory dish.

The plurality of compartments 102 may be of has various shapes and sizes such as includes but not limited to cylindrical, conical, curved and square etc. For an exemplary purpose FIG. 1 shows twelve compartments 102. However the number of compartments 102 may varies within the scope of invention. The plurality of compartments 102 may break apart from each other.

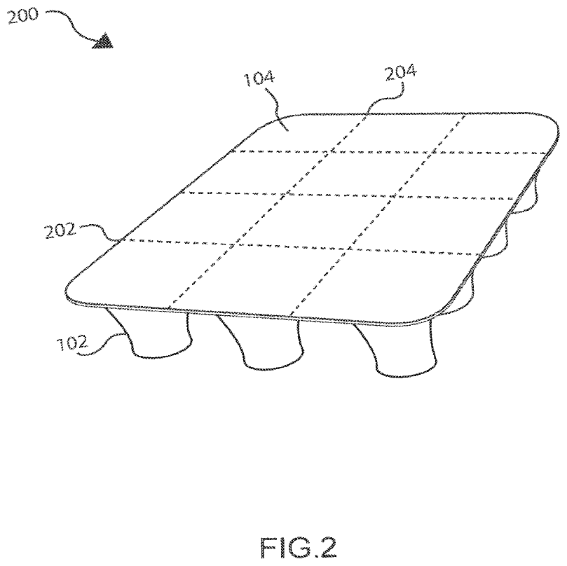

FIG. 2 illustrates a top view 200 of the apparatus for evenly storing and distributing equivalent amounts of a solution pertaining to a food or liquid, in accordance with at least one embodiment. The closing sheet 104 covers the plurality of compartments 102 from the insert top end 110 (as shown in the FIG. 1) in order to preserve the solution pertaining the food or liquid. In one embodiment, the closing sheet 104 has plurality of seal mark 202, and 204 spaced at pre-defined intervals. The seal marks 202 and 204 enable the plurality of compartments 102 to break apart from each other. In one embodiment, the covering sheet 104 receives a machine seal in order to get glued with the plurality of compartments 102.

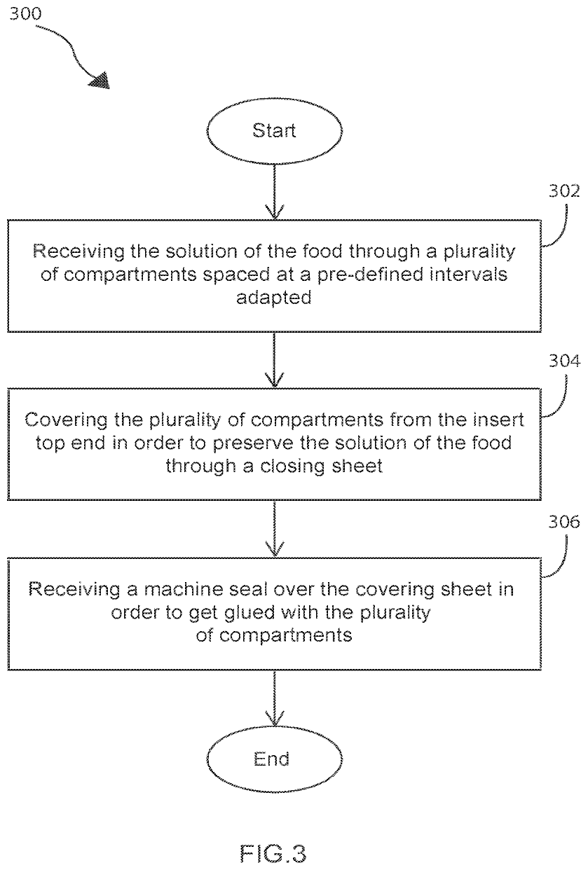

FIG. 3 illustrates a flow chart of a method 300 for evenly storing and distributing equivalent amounts of a solution pertaining to a food or liquid, in accordance with at least one embodiment. The method 300 of the present invention initiates with a step of 302 of receiving the solution of the food or liquid through a plurality of compartments spaced at pre-defined intervals adapted. In one embodiment, the plurality of compartments has a closed bottom end and an insert top end.

The step 302 is then followed by a step 304 of covering the plurality of compartments from the insert top end in order to preserve the solution of the food or liquid through a closing sheet, wherein the closing sheet has plurality of seal mark space at pre-defined intervals. The step 302 is then followed by a step 304 of receiving a machine seal over the covering sheet in order to get glued with the plurality of compartments.

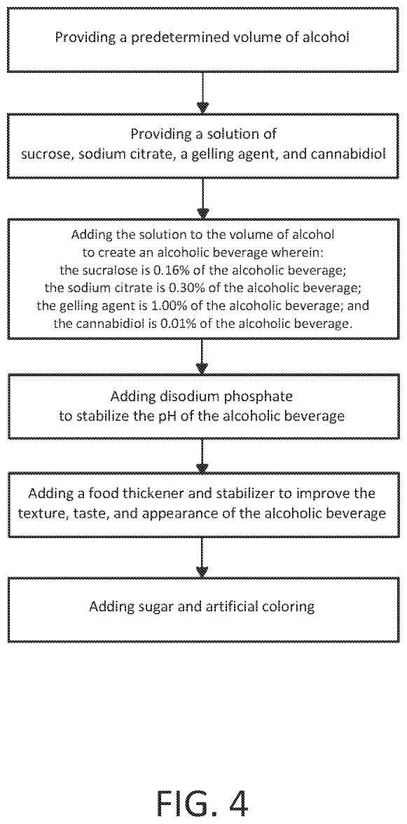

In the preferred embodiment, as illustrated in FIG. 4, the improved alcoholic beverage comprises alcohol and a solution for aiding in the consumption of the alcohol, wherein the solution includes sucralose; sodium citrate; and a gelling agent, wherein the solution is adapted to reduce the feeling of alcohol burn within the mouth and throat of a person consuming the improved alcoholic beverage.

The solution may further include disodium phosphate adapted to stabilize the pH of the solution; a food thickener and stabilizer adapted to improve the texture, taste, and appearance of said solution; sugar; and artificial coloring.

In the preferred embodiment, as illustrated in FIG. 4, the percentage of sucralose is 0.16% of the improved alcoholic beverage; the percentage of sodium citrate is 0.30% of the improved alcoholic beverage; and the gelling agent is 1.00% of the improved alcoholic beverage.

Known names of gelling agents that can be incorporated into the preferred embodiment of the improved alcoholic beverage include TICAGEL 212; GARRAGEENAN E407; AGAR, also known as AGAR-AGAR.

Disodium Phosphate and Sodium Citrate are needed to stabilize the pH of the solution. Sodium citrate also adds another shot of tartness and some saltiness to round out the flavor—think of the tang of club soda or Sprite, where it's a key ingredient. Molecular gastronomists use it in one of their culinary parlor tricks to “spherify” beverages. Carrageenan E407 is a food thickener that can be used in food as a stabilizer and thickener. Carrageenan is used to improve the texture, taste, and appearance of many foods. The use of carrageenan in candy popular in China. Carrageenan made candy has a strong fruit aroma, a moderate sweetness, and a refreshing non-stick tooth. It is also more transparent than agar-agar and has a lower price than agar-agar. It is added to hard and soft candies in general. It Can make the product taste smooth, more flexible, low viscosity, increased stability. Food grade carrageenan has been independently evaluated by the Joint FAO*/WHO* Expert Committee on Food Additives (JECFA), an international panel of expert toxicologists who review data and develop recommendations about food ingredients. JECFA determined that food grade carrageenan was a safe food additive with no limits on its use in food. Agar is a gelling agent, used in industry in lieu of gelatin in products such as jellies, candies, cheeses, and glazes. Since agar is vegetarian, it's a good substitute in dishes that traditionally call for gelatin, which is derived from animal skins and bones. Agar has a slight taste, though, so it works best with strongly flavored dishes. Sometimes called agar-agar it is perhaps the oldest of all the food additives commonly used in industry, but has only recently become known in western cuisines, mostly as a vegetarian substitute for gelatin. One advantage to using agar-agar over gelatin is that it stays firm even when it's warm. (Probably why our premade gelatin shots don't require refrigeration.) Sucralose is an artificial sweetener and sugar substitute. The majority of ingested sucralose is not broken down by the body, so it is non-caloric. In the European Union, it is also known under the E number E955. Sucralose is 600 times sweeter than sugar, and it can be used in place of or combined with sugar in cooking and baking. Sucralose has been studied extensively and has been found to be safe by experts and researchers around the world.

The following is how ingredients are used to flavor known JELLO:
Sugar—Gelatin is colorless, odorless, and flavorless, so most of the other ingredients are here to fix that. According to the “Nutrition Facts” on the box JELL-O powder is 90 percent sugar by weight.
Artificial Flavors—Taste is a crude sense—your tongue perceives only five different values. So to evoke specific fruit flavors, chemists rely on volatile esters that send subtler hints to your nose. KRAFT won't say what it deceives our taste buds with, but some usual suspects are octyl-acetate for orange flavor, methyl anthranilate for grape, and ethyl-methylphenylglycidate to whisper strawberry.
Artificial Colors—Cheap petroleum-based dyes make for intense shock-and-awe hues. They're also more stable than natural colors, which matters in a product that might sit on your shelf for years. Strawberry Jell-O uses the disodium salt of 6-hydroxy-5-[(2-methoxy-5-methyl-4-sulfophenyl)azo]-2-naphthalenesulfonic acid—aka Red 40.

As illustrated in FIG. 4, the improvement from the previous embodiments is to further include cannabidiol, a substance which is sometimes referred to as “CBD”. The resulting combination of ingredients for the solution becomes sucralose, sodium citrate, a gelling agent, and cannabidiol, wherein the solution is adapted to reduce the feeling of alcohol burn within the mouth and throat of a person consuming alcohol along with the instant solution, and which further includes the health benefits of cannabidiol.

In the preferred embodiment, as illustrated in FIG. 4, the percentage of sucralose is 0.16% of the improved alcoholic beverage; the percentage of sodium citrate is 0.30% of the improved alcoholic beverage; the gelling agent is 1.00% of the improved alcoholic beverage; and the cannabidiol is 0.01% of the improved alcoholic beverage.

Cannabidiol is a popular natural remedy used for many common ailments. Better known as CBD, it is one of over 100 chemical compounds known as cannabinoids found in the cannabis or marijuana plant, Cannabis sativa. Tetrahydrocannabinol (THC) is the main psychoactive cannabinoid found in cannabis, and causes the sensation of getting “high” that's often associated with marijuana. However, unlike THC, CBD is not psychoactive. This quality makes CBD an appealing option for those who are looking for relief from pain and other symptoms without the mind-altering effects of marijuana or certain pharmaceutical drugs. CBD oil is made by extracting CBD from the cannabis plant, then diluting it with a carrier oil like coconut or hemp seed oil. In the instant invention, the preferred form and percentage is 0.01%, though other percentages can be used.

The advantages and benefits of including cannabidiol include pain relief, reducing anxiety and depression, alleviate cancer related symptoms including nausea and vomiting, possibly reducing acne, neuroprotective properties, improve heart health, provide antipsychotic effects, help prevent the spread of cancers, and even help prevent diabetes.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope.

What is claimed is:

1. A solution for aiding in the consumption of alcoholic beverages, wherein said solution includes:
sucralose;
sodium citrate;
a gelling agent; and
cannabidiol;
wherein said solution is adapted to reduce the feeling of alcohol burn within the mouth and throat of a person consuming an alcoholic beverage mixed with said solution and include the health benefits of cannabidiol.

2. The solution of claim 1, further including disodium phosphate adapted to stabilize the pH of said solution.

3. The solution of claim 1, further including food thickener and stabilizer adapted to improve the texture, taste, and appearance of said solution.

4. The solution of claim 1, further including sugar.

5. The solution of claim 1, further including an artificial coloring.

6. The solution of claim 1, wherein
said sucralose is 0.16% of said alcoholic beverage;
said sodium citrate is 0.30% of said alcoholic beverage;
said gelling agent is 1.00% of said alcoholic beverage; and
said cannabidiol is 0.01% of said alcoholic beverage.

7. The solution of claim 1, wherein said gelling agent is TICAGEL 212.

8. The solution of claim 1, wherein said gelling agent is GARRAGEENAN E407.

9. The solution of claim 1, wherein said gelling agent is AGAR.

10. An improved alcoholic beverage comprising:
alcohol; and
a solution for aiding in the consumption of said alcohol, wherein said solution includes:
sucralose;
sodium citrate;
a gelling agent; and
cannabidiol;
wherein said solution is adapted to reduce the feeling of alcohol burn within the mouth and throat of a person consuming said improved alcoholic beverage and include the health benefits of cannabidiol.

11. The improved alcoholic beverage of claim 10, wherein said solution further includes disodium phosphate adapted to stabilize the pH of said solution.

12. The improved alcoholic beverage of claim 10, wherein said solution further includes food thickener and stabilizer adapted to improve the texture, taste, and appearance of said solution.

13. The improved alcoholic beverage of claim 10, wherein said solution further includes sugar.

14. The improved alcoholic beverage of claim 10, wherein said solution further includes artificial coloring.

15. The improved alcoholic beverage of claim 10, wherein:
said sucralose is 0.16% of said alcoholic beverage;
said sodium citrate is 0.30% of said alcoholic beverage;
said gelling agent is 1.00% of said alcoholic beverage; and
said cannabidiol is 0.01% of said alcoholic beverage.

16. The improved alcoholic beverage of claim 10, wherein said gelling agent is TICAGEL 212.

17. The improved alcoholic beverage of claim 10, wherein said gelling agent is GARRAGEENAN E407.

18. The improved alcoholic beverage of claim 10, wherein said gelling agent is AGAR.
